(19) United States
(12) Patent Application Publication
(10) Pub. No.: US 2007/0051794 A1
(43) Pub. Date: Mar. 8, 2007

(54) Credit proxy system and method

(75) Inventors: Gary T. Glanz, Southampton, NY (US); Steven Yevoli, New York, NY (US); Jed Schutz, Sag Harbor, NY (US); Jonathan B. Goldberg, Northport, NY (US)

Correspondence Address: GREENBERG TRAURIG, LLP, MET LIFE BUILDING, 200 PARK AVENUE, NEW YORK, NY, 10166, US

(73) Assignee: Nimble Group, Inc., New York, NY (US)

(21) Appl. No.: 11/219,458

(22) Filed: Sep. 2, 2005

(51) Int. Cl. G07F 19/00; G06K 15/00; G06Q 20/00

(52) U.S. Cl. 235/379; 235/383; 705/16

(57) ABSTRACT

Methods and apparatus for providing the shifting of fees associated with accepting various forms of electronic payment from the retailer to the customer by using a credit proxy. A credit proxy is provided that adds a fee to the monetary value of a transaction, and obtains authorization to approve the transaction from the issuer of the customer's account. In an approved transaction, the customer is charged for the monetary value plus the fee, and the retailer is credited with the monetary value. Thus, the retailer receives the full value of their goods and/or services, and the customer pays for the fees associated with electronic payments.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

Various embodiments of the present invention relate to the field of electronic payments. For example, in an illustrative and non restrictive embodiment, the transaction fees normally charged to a retailer completing a credit card sale are shifted to the consumer.

### BACKGROUND OF THE INVENTION

Credit cards and other forms of electronic payment are accepted at stores and establishments around the world. Many people like to use their cards when making purchases because credit cards provide many advantages, such as, for example, purchasing power, purchase protection, rewards, the convenience of not having to carry cash, etc. People in a hurry do not want to bother with counting cash and waiting for change, they may prefer to swipe a card and continue with their business. In addition, professionals on business trips like to have a record of their expenses so they can properly report their charges to their superiors.

Most credit card companies charge the retailer a service fee for every electronic transaction accepted by the retailer. Often a transaction fee includes a processing fee and an interchange fee. The processing fee is often between $ 0.10 and $ 0.15, but often varies with the typical transaction sizes, volumes and negotiating power of the retailer. The interchange fee is usually a percentage of the sale price, and is often between 1.5% and 2.5%, however, as with the processing fee, the transaction fee can be higher or lower, with some credit processors charging 4% or more. The processing and interchange fees can make sales economically unsound for a retailer, for example, a discounter that operates on small margins. Moreover, the fees can represent a large percentage of the purchase for a small sale, and a hefty fee for a large sale. Accordingly, many retailers do not accept credit cards as an option to their customers to make payments. Or, if the retailer accepts credit cards, they may insist that the customer purchase a minimum amount that is higher than the customer's desired purchase amount. This often results in lost sales and/or unhappy customers. Moreover, since customers using credit cards generally spend more than customers using cash, this results in lower gross revenue for the retailer.

Accordingly, there is a desire for methods and apparatus that allows a retailer to accept a form of electronic payment without the need to pay transaction fees.

### SUMMARY OF THE INVENTION

The invention as described and claimed herein satisfies this and other needs, which will be apparent from the teachings herein.

In one embodiment, there is a method of charging electronic payment fees to a customer comprising, receiving a first transaction authorization request from a retailer, the first transaction authorization request comprising a customer account identifier and a monetary value for a transaction; transmitting a second transaction authorization request to a credit processor, the second transaction authorization request comprising the customer account identifier and a total transaction cost, the total transaction cost comprising a surcharge added to the monetary value; receiving an authorization for the second transaction request from the credit processor; receiving a net credit from the credit processor; creating a credit in favor of the retailer; and the credit processor creating a charge to the customer in the amount of the total transaction cost.

In one embodiment, there is a credit proxy computer coupled to a communication network, the credit proxy computer comprising: a processor; a communication module; and memory, having stored thereon at least one routine, said routine executing commands comprising: receiving a request from a terminal to approve a transaction, the request including a first value; calculating a second value by adding a surcharge to the first value; contacting a credit processor to obtain authorization to approve the transaction, the request including the second value; receiving a decision from the credit processor; and providing an indication of the decision to the terminal.

In one embodiment, there is a charge system for permitting a customer to tender payment to a retailer in the form of a credit card, the charge system comprising: a terminal for receiving information transaction information comprising a customer account identifier and a transaction value; the terminal being adapted to transmit a request for authorization to a merchant system and to receive an indication of the result of such authorization request from the merchant system; the merchant system being adapted: to compute a surcharge to the transaction value, to transmit a request for authorization to a credit processing system, the request including the surcharge, to receive an indication of the result of such authorization request from the credit processing system, to receive a credit from the credit processing system, and to provide a credit to an account associated with the terminal; and the credit processing system being adapted to receive requests for authorization, to make credits for approved requests, and to charge an account associated with the customer account identifier in the amount of any approved request.

In one embodiment, there is a terminal comprising: an account identifier capture module; a monetary value receiver; and a communication module, wherein said terminal uses the communication module in at least one routine comprising, requesting an authorization from a credit proxy system to approve a transaction for a first amount, the credit proxy system obtaining authorization for a transaction from a credit processor for a second amount; and receiving an indication of the decision for said authorization request of the transaction for the second amount, and if the indication is positive, receiving an indication of the second amount.

Other embodiments, additional features and advantages of the invention will be set forth in the description which follows, and in part will be apparent from the description, or may be learned by practice of the invention. The objectives and other advantages of the invention will be realized and attained by the methods and structures particularly pointed out in the written description and claims hereof as well as the appended drawings.

It is to be understood that both the foregoing general description and the following detailed description are illustrative and not restrictive and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a high level illustration of a credit transaction known in the art.

FIG. 2A is a high level illustration of a credit transaction implemented in accordance with one embodiment of the invention.

FIG. 2B is a high level illustration of a credit transaction implemented in accordance with one embodiment of the invention, where authorization from a customer is received before requesting a credit proxy/merchant to authorize a transaction with a credit processor.

FIG. 3 is a high level illustration of a system implemented in accordance with one embodiment of the invention.

FIG. 4 is a high level illustration of messages transmitted in a transaction implemented in accordance with one embodiment of the invention.

FIG. 5 is a high level illustration of a credit proxy method, executed at a terminal, implemented in accordance with one embodiment of the invention.

FIG. 6 is a high level illustration of a credit proxy method, executed at a credit proxy computer, implemented in accordance with one embodiment of the invention.

FIG. 7 is a high level illustration of a chargeback method implemented in accordance with one embodiment of the invention.

FIG. 8 is a high level illustration of a return/credit method implemented in accordance with one embodiment of the invention.

FIG. 9 is a schematic representation of a transaction implemented in accordance with one embodiment of the invention.

### DETAILED DESCRIPTION OF EMBODIMENTS OF THE INVENTION

The term credit card, as used herein, unless otherwise specified expressly or by context, is intended to have a broad non-limiting definition, and refers, without limitation, to all of the following payment forms: credit cards (e.g., MasterCard or Visa), charge cards (e.g., American Express), debit, ATM or bank cards and stored value cards such as gift cards or store credit cards.

The term retailer as used herein, unless otherwise specified expressly or by context, is intended to have a broad non-limiting definition, and refers, without limitation, to the following types of entities: vendors of any manner of goods and/or services, a store, a service provider, a government agency and any other entity that accepts payment.

The term customer as used herein, unless otherwise specified expressly or by context, is intended to have a broad non-limiting definition, and refers, without limitation, to the following types of entities: a purchaser of any manner of goods and/or services, a tax payer, a third party benefactor, and any other entity that provides payment.

Reference will now be made in detail to illustrative embodiments of the present invention, examples of which are shown in the accompanying drawings. Many business owners do not accept electronic payments, because the fees associated with receiving electronic payments can reduce the economic value of a sale. Embodiments of the invention offer methods and apparatus for offering a credit proxy service that shifts the payment of the fees from a retailer to a customer.

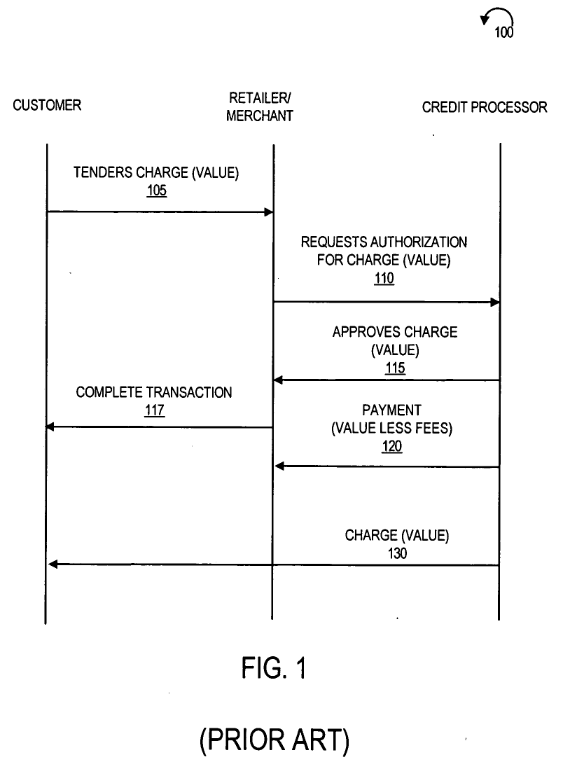

Turning first to FIG. 1, a prior art credit card transaction is shown. In a typical prior art credit card transaction, as shown at step 105 a customer tenders a charge card to a retailer, and authorizes the retailer to process a charge in the amount of a value. The retailer requests a credit processor to authorize a charge of the specified value at step 110. When a charge is approved by the credit processor, it provides that approval to the retailer at step 115. Although the credit processor can deny the charge, FIG. 1 illustrates only the approval of the charge. After the retailer receives the approval, it may complete the transaction with the customer, as illustrated at step 117. Completing the transaction may, but need not include, e.g., printing a receipt. The credit processor then pays the retailer the value of the transaction less fees at step 120. The fees generally include both processing and interchange fees. The processing fee is often between $ 0.10 and $ 0.15, but often varies with the typical transaction sizes, volumes and negotiating power of the retailer. The interchange fee is usually a percentage of the sale price, and is often between 1.5% and 2.5%, however, as with the processing fee, the interchange fee can be higher or lower, with some credit processors charging 4% or more. Finally, at step 130, the credit processor will charge the customer for the value of the transaction.

For illustrative purposes, and not by way of limitation, assume that the processing fee is $ 0.10, and the interchange fee is 1.5%. If the value of the charge at step 105 were $ 2.00, the retailer would receive a payment of $ 1.87 at step 120, and the customer would be charged $ 2.00 at step 130. If, on the other, hand, the value of the charge at step 105 were $ 20.00, the retailer would receive a payment of $ 19.60 (i.e., $ 20.00 minus a processing fee of $ 0.10 minus an interchange fee of 1.5% or $ 0.30) at step 120, and the customer would be charged $ 20.00 at step 130.

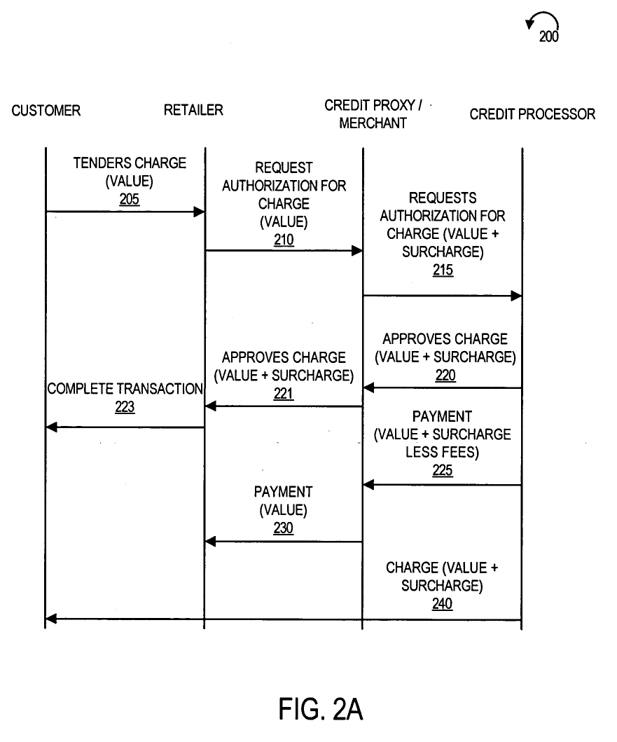

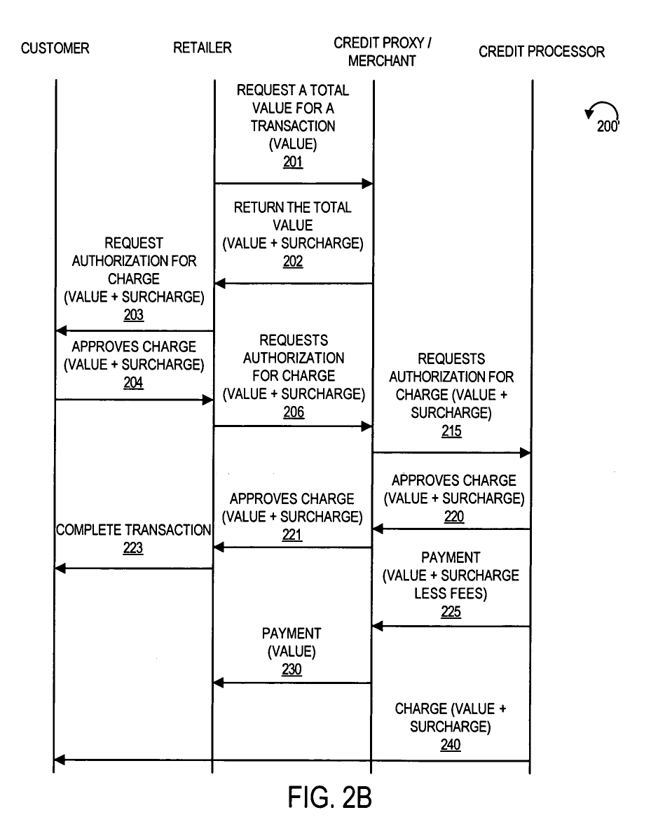

Turning now to FIG. 2A, a credit card transaction according to one embodiment of the invention is shown. In the inventive credit card transaction, as shown at step 205 a customer tenders a charge card to a retailer, and authorizes the retailer to process a charge in the amount of a value. The retailer requests a credit proxy that will act as the merchant of record to authorize a charge of the specified value at step 210. At step 215, the merchant, in turn, requests that the credit processor authorize a charge, however, the credit proxy/merchant has added a surcharge to the value, and thus requests authorization for a larger value than the request from the retailer at 210. The surcharge may be a fixed fee, a percentage of the transaction value, a sliding percentage of the transaction value, or a combination of the foregoing. In one embodiment, the surcharge may be an amount larger than any fees that may be charged by the credit processor. In one embodiment, the surcharge is $ 0.50 plus 2.5% of the transaction value.

When a charge is approved by the credit processor, it provides that approval to the merchant at step 220. At step 221, the merchant provides the approval for the charge, along with the surcharge, to the retailer. Although the credit processor can deny the charge, FIG. 2A illustrates only the approval of the charge. After the retailer receives the approval, it may complete the transaction with the customer, as illustrated at step 223. Completing the transaction may, but need not include, e.g., printing a receipt. In one embodiment, a printed receipt reflects the amount of the value plus the surcharge. The credit processor then pays the merchant the value plus the surcharge, less its fees at step 225. In one embodiment, (not shown) the credit processor does not immediately take out their fee, and credits the merchant the value plus the surcharge at step 225. Instead, the credit processor can make a batch debit at the end of a time period (e.g., a month). Taking credit processor fees at the end of the time period helps to reduce rounding remainders when calculating percentage fees. In one embodiment (not shown), the credit processor settles the value of the transaction with the retailer and separately settles the surcharge with the merchant. The credit processor can take its fee before settling the value of the transaction with the retailer, or in a batch fee at the end of a time period. In one embodiment (not shown), the credit processor can credit the retailer the value plus the surcharge, and the merchant can debit the retailer for their fees. The credit processor can take their fees before crediting the retailer or in a batch from the merchant at the end of a pay period. The credit processor's fees generally include both processing and interchange fees. The processing fee is often between $ 0.10 and $ 0.15, but often varies with the typical transaction sizes, volumes and negotiating power of the retailer. The interchange fee is usually a percentage of the sale price, and is often between 1.5% and 2.5%, however, as with the processing fee, the interchange fee can be higher or lower, with some credit processors charging 4% or more. At step 230, the merchant pays the retailer the value of the transaction. Finally, at step 240, the credit processor will charge the customer for the value of the transaction.

When determining the percentage fee portion of the surcharge, such as, for example, the interchange fee, in one embodiment, the percentage of the value plus the surcharge is rounded to the nearest penny. For example, if a value plus surcharge is $ 21.50 and an interchange fee is 1.5%, then 1.5% of $ 21.50 is $0.3225, so the surcharge is at least $ 0.32 cents. In one embodiment, the percentage of the value plus the surcharge is increased to the next penny. For example, if a value plus is $ 21.50 and an interchange fee is 1.5%, then 1.5% of $ 21.50 is $0.3225, so the surcharge is at least $ 0.33 cents.

Individual retailers may not have the transaction size or volumes to effectively negotiate lower processing and interchange fees with a credit processor. On the other hand, a credit proxy/merchant representing the collective transactions of a plurality of retailers will have more bargaining power. Especially since the credit proxy/merchant is attracting retailers who may normally forgo offering credit card payments to their customers. Having lower processing and interchange fees allows the credit proxy/merchant to charge less for its service, thus encouraging customers to use their credit cards.

As an example, and not by way of limitation, the credit proxy/merchant may price its fees at an amount that will yield a profit. As an example, and not by way of limitation, where the credit processor's fees are $ 0.10 and 1.5%, the credit proxy/merchant may price its surcharge at $ 0.50 and 2.5% yielding a gross profit of $ 0.40 and 1% per transaction.

For illustrative purposes, and not by way of limitation, assume that the credit processor's processing fee is $ 0.10, and the interchange fee is 1.5%, and assume that the credit proxy/merchant's surcharge is $ 0.50 and 2.5%. If the value of the charge at step 205 were $ 2.00, the credit proxy/merchant would receive a net payment of $ 2.41 at step 225, the retailer would receive a payment of $ 2.00 at step 230, and the customer would be charged $ 2.55 at step 240—leaving a profit for the merchant of $ 0.41. As mentioned above, in one embodiment, the credit processor can credit the merchant $ 2.55 at step 225, and obtain their $ 0.14 fee as part of a batch debit at the end of a time period. The credit processor may not receive exactly $ 0.14 for this transaction, since the percentage interchange fee is calculated from a plurality of transactions at the end of a time period. If, on the other hand, the value of the charge at step 205 were $ 20.00, the credit proxy/merchant would receive a net payment of $ 20.58 at step 220, the retailer would receive a payment of $ 20.00 at step 230, and the customer would be charged $ 21.00 at step 240—leaving a profit for the merchant of $ 0.58.

In one embodiment, the merchant may charge the retailer a small fee per transaction—such a fee may be less than the credit processing fees—thus allowing the merchant a lower cost method of accepting credit cards while further increasing the merchant's profitability. In one embodiment the merchant may pay the retailer more than the value of the transaction, sharing with the retailer a portion of it's profitability. Such an embodiment may help generate interest in accepting credit cards by retailers.

Now turning to FIG. 2B, a credit card transaction 200′ according to one embodiment is shown. In one embodiment, the retailer presents the customer with the total of the value and the surcharge, and requests authorization to proceed, before requesting the credit proxy/merchant contact the credit processor. Therefore, in step 201, the retailer transmits a request comprising a value of a transaction to the credit proxy/merchant, asking the credit proxy/merchant for the total cost of the transaction. The credit proxy/merchant receives the request, adds a surcharge to the received value and transmits the total to the retailer in step 202. In step 203, the retailer informs the customer of the value plus the surcharge, and requests authorization from the customer to proceed with the transaction. In step 204, the customer approves the transaction and tenders charge. For example, the customer can present their credit card to the retailer, or can personally swipe their card at a terminal. In one embodiment, the customer's authorization can include a signature. In one embodiment, the customer can tender charge before the retailer obtains a total value of the transaction (not shown).

Then, in step 206, the retailer requests authorization to complete the transaction from the credit proxy/merchant. In one embodiment, the retailer can send the value plus the surcharge back to the credit proxy/merchant with the request. In one embodiment, the customer's signature is also sent to the credit proxy/merchant with the request. After receiving the request the credit proxy/merchant proceeds to step 215. In one embodiment, the retailer can send a message to the credit proxy/merchant informing the credit proxy/merchant that the customer has approved the transaction, and that the credit proxy/merchant should proceed to steps 215. Steps 215 to 240 are then executed as described above.

In one embodiment, instead of requesting the total value of the transaction (i.e., value plus surcharge) from the credit/merchant, as illustrated in steps 201 and 202; the total value of the transaction can be calculated by a terminal at the retailer. If the total value of the transaction is calculated by a terminal, steps 201 and 202 can be omitted from transaction 200′. In one embodiment, the credit proxy/merchant can periodically send instructions to the terminal defining the amount of surcharges that should be added to a value. For example, updated instructions can be sent to retailers each morning and/or when requested from the terminal.

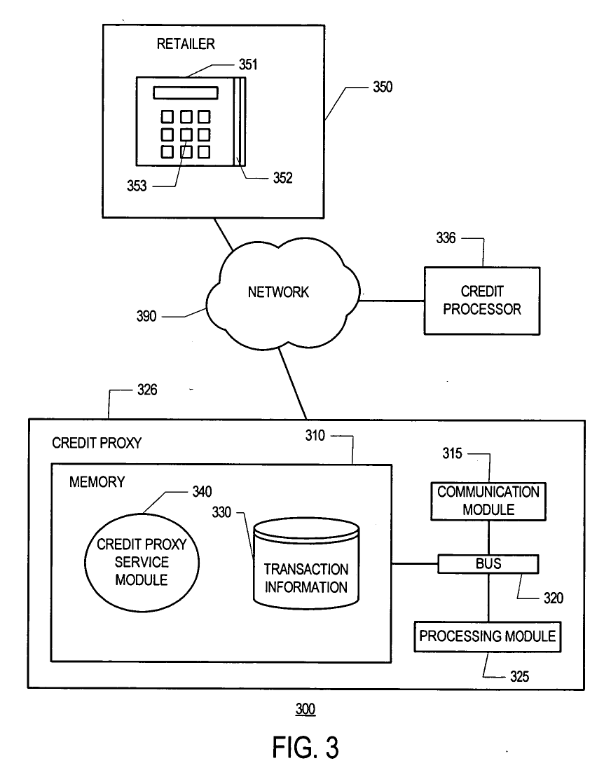

With reference to FIG. 3, there is shown a block diagram of a system 300 implemented in accordance with one embodiment of the invention. System 300 comprises a retailer 350, a credit proxy 326, and a credit processor 336, each coupled to a network 390. Although FIG. 3 illustrates network 390 as a single symbol, the retailer 350, the credit proxy 326 and the credit processor 336 can be coupled together by the Internet, by other networks, or by any combination of the Internet and other networks, as is well known in the art. For example, the retailer 350 and the credit proxy 326 can be coupled together through the Internet, while the credit proxy 326 and the credit processor 336 are coupled together through a private bank network.

Retailer 350 can, for example, be a store, a taxi, a fruit stands salesmen or any other person or entity that wants to collect payment. In one embodiment of the invention, the retailer 350 possesses a terminal 351 that is used to receive payment information from customers and to communicate with the credit proxy service provider 326. The terminal 351 comprises a module for capturing account identifiers. For example, terminal 351 comprises a magnetic strip reader 352, for receiving credit and/or debit cards. In addition, the terminal 351 may also comprises a module for receiving a monetary value. For example, the terminal 351 comprises an input device 353, which can be a keypad or other interface (not shown), which can be used to provide the value of a transaction. In one embodiment, the input device 353 can receive a retailer reference number, for example, from the retailer's accounting system. The input device 353 could also be used to provide an account identifier, if, for example, the magnetic strip of a credit card is damaged.

In one embodiment of the invention, account identifiers and monetary values can be received by the terminal 351 in other ways, such as, for example, the terminal 351 can comprise a computer interface, a data form scanner, a barcode scanner, a radio frequency identification (RFID) reader, a camera, etc. In addition, in embodiments of the invention, the terminal 351 can be coupled to another computer, such as, for example, a point of sale (POS) terminal, and can receive customer and other information over the computer interface, from the POS terminal. The terminal 351, can also comprise a signature capture pad, and/or a printer for printing out receipts.

In one embodiment of a transaction executed according to the invention, a credit card holder (i.e., customer) who wants to pay for goods, services, taxes or even debts, is informed that in order to make an electronic payment they will be charged a fee. In one embodiment, the terminal 351 may bear a label so that a customer is aware that a fee will be applied to the transaction. If a customer wants to proceed, the terminal 351 is provided the customer's account identifier, for example, by swiping a credit card through the terminal 351 or by entering it into the terminal 351. In one embodiment, the customer must enter a PIN associated with the credit card. The terminal 351 may also be provided with a monetary value for the transaction, for example, by inputting the monetary value in a keypad or having the value input directly from a cash register or other POS device. The terminal 351 causes a transaction, comprising at least an account identifier and an amount to be transmitted to a credit proxy computer 326 for approval or disapproval. In one embodiment, the terminal 351 comprises a communication module 315 that can have a wired or wireless connection to network 390. For example, the wireless connection can be established though a cellular network, WiFi, and/or over any other wireless network. In one embodiment, the terminal 351 can connect with a credit proxy computer 326 through another computer that is coupled to network 390. In one embodiment, the transmission of a transaction across network 390 from the terminal 351 to the credit proxy computer 326 includes a step of authentication as is well known to those of skill in the art.

Credit proxy computer 326 comprises a processing module 325, a communication module 315 and memory 310 that may be coupled together by a bus 320. The modules of computer 326 can be implemented as any combination of hardware, software, firmware, emulators and reprogrammable hardware. The bus 320 need not be a single bus, but rather, illustrates the interoperability of the different modules of the computer 326. In one embodiment, there may be multiple busses. In one embodiment, some modules are directly coupled instead of coupled via a bus 326. Credit proxy computer 326 can be implemented as a computer, such as, for example, personal computer, as is well known in the art.

Appropriate software operating on credit proxy computer 326 provides its functionality. The processing module 325 comprises one or more central processing units (CPUs), Field-Programmable Gate Arrays (FPGA), or any other component capable of executing computer instructions. Communication module 315 comprises one or more I/O components used by the computer 326 to communicate with users and other devices. For example, the communication module 315 facilitates two way communication between the computer 326 and other electronic devices over a network 390, such as, for example, terminal 350 and credit processor 336. Components such as a modem, a network interface card (NIC), a wireless adapter, a Universal Serial Bus (BUS) adapter, etc., can be used by the computer 326 to communicate with the network 390, and/or with peripheral devices. The computer 326 can be communicatively connected to the network 390 through the communication module 315, for example, over one or more transmission media including but not limited to coaxial cable, copper wires and fiber optic cables. Communication between the communication module 315 and the network 390 may also be accomplished via wirelessly.

In one embodiment, memory 310 provides electronic data storage using a combination of main memory (e.g., RAM) and drive storage. Any type of appropriate electronic memory can be used, including, without limitation, RAM, ROM, drive storage (hard, floppy, optical, etc.), non-volatile memory (e.g., flash) or any other memory that can store data. While memory 310 is illustrated with single box around it in FIG. 3, memory 310 as discussed above, memory 310 can comprise one, two or more different types of modules of memory. In the embodiment illustrated in FIG. 3, memory 310 has stored thereon a credit proxy service module 340 and transaction information 330. In one embodiment, credit proxy service module 340 is implemented in software executed by the credit proxy computer 326, and more specifically, by the processing module 325.

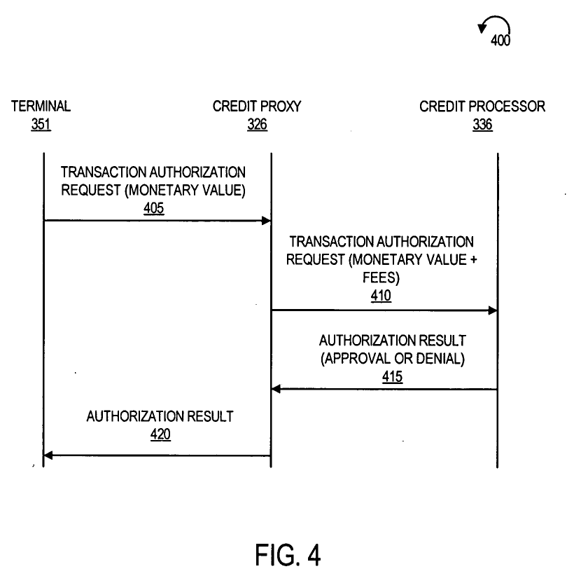

FIG. 4 illustrates a high level diagram of the transmittal of messages in a credit proxy method 400 that can be executed by the credit proxy computer 326. The method 400 begins with the terminal 351 sending a request to authorize a transaction in step 405. Although shown only as unidirectional communications, as is well known in the art, this step may comprise authentication, error correction, acknowledgements and other related communications between the terminal 351 and the credit proxy 326. In one embodiment, the request includes a monetary value and an account identifier. In one embodiment, the request includes a retailer reference number. The account identifier identifies the account, for example, a credit card number. In one embodiment, the monetary value represents the amount of the transaction, for example, a sale (positive) or a return (negative); in one embodiment, the monetary value represents the amount of the transaction plus the amount of a fee associated with the transaction. The retailer reference number can be, for example, a reference number created by the retailer's accounting system, which the retailer used to monitor their transactions.

Once the request is received by the credit proxy 326, the credit proxy 326 then seeks authorization for the transaction 410 from the credit processor 336.

In one embodiment, the credit proxy 326 increases the monetary value for which it seeks authorization to include a surcharge larger than the credit processor's 336 fees of the transaction. To illustrate, consider an example, where the fees charged by the credit processor 336 are $ 0.10 per transaction, plus a 1.5% interchange fee, and a surcharge charged by the merchant/credit proxy are $ 0.50 per transaction plus 2.5% of the value of the transaction. Where the monetary value of the transaction transmitted by the terminal 351 is $ 20.00, according to one embodiment of the invention, the credit proxy 326 requests authorization for $ 21.00-$ 20.00 is the amount requested by the retailer via the terminal 351; $ 0.50 is the processing fee; $ 0.50 is 2.5% of the value of the transaction. In such an example, the retailer receives $ 20.00, the customer is charged $ 21.00, the credit processor 336 receives $ 0.42, while the credit proxy 326 receives $ 0.58. As mentioned above, in one embodiment, the retailer receives $20.00, the customer is charged $21.00 and the credit proxy 326 receives $1.00. The credit processor 336 obtains their $ 0.42 fee from the credit proxy 326 as part of a batch debit at the end of a time period.

In one embodiment, the credit proxy 326 increases the monetary value for which it seeks authorization to include the credit processor's 336 fees of the transaction. To illustrate, consider an example, where the fees charged by the credit processor 336 were $ 0.10 per transaction, plus a 1.5% interchange fee. Where the monetary value of the transaction transmitted by the terminal 351 is $ 20.00, according to one embodiment of the invention, the credit proxy 326 requests authorization for $ 20.41-$ 20.00 is the amount requested by the retailer via the terminal 351; $ 0.10 is the processing fee; $ 0.31 is 1.5% of the total amount requested, to the nearest penny.

In one embodiment, the credit proxy 326 increases the monetary value for which it seeks authorization to include the credit processor's fees of the transaction, as well as additional fees for the credit proxy 326 service. To illustrate, consider an example, where the fees charged by the credit processor 336 were $ 0.10 per transaction, plus 1.5%, and the fees charged by the merchant/credit proxy 326 are $ 0.50 per transaction. Where the monetary value of the transaction transmitted by the terminal 351 is $20.00, according to one embodiment of the invention, the credit proxy 326 requests authorization for $ 20.91-$ 20.00 is the amount requested by the retailer via the terminal 351; $ 0.50 is the transaction fee for the merchant/credit proxy 326; $ 0.10 is the processing fee for the credit processor 336; $ 0.31 is 1.5% of the total amount requested, to the nearest penny.

In one embodiment, the retailer terminal 351 may additionally charge a fee. To illustrate, consider an example, where the fees charged by the credit processor 336 were $ 0.50 per transaction, plus 2.5%, the fees charged by the credit proxy 326 are $ 0.50 per transaction, and the fees charged by the retailer's terminal 351 are also $ 0.50 per transaction. Where the monetary value of the transaction transmitted by the terminal 351 is $20.00, according to one embodiment of the invention, the credit proxy 326 requests authorization for $ 22.05-$ 20.00 is the amount requested by the retailer via the terminal 351; $ 0.50 is the processing fee for the credit processor 336; $ 0.50 is the transaction fee for the credit proxy 326; $ 0.50 is the transaction fee for the retailer's terminal 351; $ 0.55 is 2.5% of the total amount requested, to the nearest penny.

In one embodiment, the customer might use a debit card to pay for the transaction. Credit processors 336 normally do not charge percentage fees in debit transactions. The credit proxy 326 can choose to forgo percentage fees. To illustrate, consider an example, where the fees charged by the credit processor 336 are $ 0.10 per transaction, and a surcharge charged by the credit proxy 326 is $ 0.50 per transaction. Where the monetary value of the transaction transmitted by the terminal 351 is $ 20.00, according to one embodiment of the invention, the credit proxy 326 requests authorization for $ 20.60-$ 20.00 is the amount requested by the retailer via the terminal 351; $ 0.10 is the processing fee credited to the credit processor; and $ 0.50 is the transaction fee charged by the credit proxy 326. In one embodiment, the credit proxy 326 can charge a percentage fee for their service. As mentioned above, in one embodiment, the retailer is credited $20.00, the customer is charged $20.60 and the credit proxy 326 receives $ 0.60. The credit processor 336 obtains their $ 0.10 fee from the credit proxy 326 as part of a batch debit at the end of a time period.

The foregoing illustrations are provided by way of example, and are not intended to limit the manner in which the credit proxy 326 can charge its fees or the types or amounts of fees it can charge. In one embodiment, the credit proxy 326 charges a sliding percentage of a transaction so that its fees are a larger percentage of smaller transactions. In one embodiment, the credit proxy 326 charges a flat fee, and passes through the processing fee of the credit processor 336. In one embodiment, when the credit processor 336 takes their fees at the end of a time period, they may take a little more or a little less than allocated in a surcharge to a customer because of remainders that may occur when calculating percentage fees.

As known in the art, a credit processor 336 is a data processing company that may operate in partnership with a bank. The bank's relationship with a credit card company, such as, for example, Visa™ and/or MasterCard™, enables the credit processor 336 to process credit card transactions on behalf of the banking industry. In some embodiments, the bank can also act as a credit processor 336. Although method 400 is described using a credit processor 336, the invention can also be implemented with any entity that can approve or otherwise guarantee the payment of a transaction value.

After the credit processor 336 receives the authorization request, the credit processor 336 determines whether to approve the transaction as is well known in the art, for example, by examining the available finds or credit in the account identified by the account identifier. The credit processor's 336 authorization result (i.e., approval or denial) is transmitted, in step 415, to the credit proxy 326, and in step 420, the authorization result forwarded to the requesting terminal 351. If a transaction is approved, the credit proxy 326 may settle the transaction value with the credit processor 336, and credit the retailer 350 the value entered at the terminal 351. In one embodiment, as is well known in the art, the customer is provided a receipt showing the total monetary value that was charged to the account identified by the account identifier for the transaction. It should be noted that the customer paying at the terminal 351 pays all of the fees, while the retailer is given the entire amount charged for the transaction. This differs from conventional credit card transactions where the retailer would be responsible for payment of the transaction fees. In one embodiment, a record of the transaction is stored in transaction information 330. The transaction record may be used for settlement purposes and may thereafter be retained as a record in accordance with a document retention policy. As is well known in the art, if the transaction is denied at step 420, the terminal 351 may ask for another form of payment. In one embodiment, a receipt evidencing the denial is caused to be generated by the terminal 351. A more detailed description of a credit proxy 326 service transaction is given with the description of the flow diagrams below.

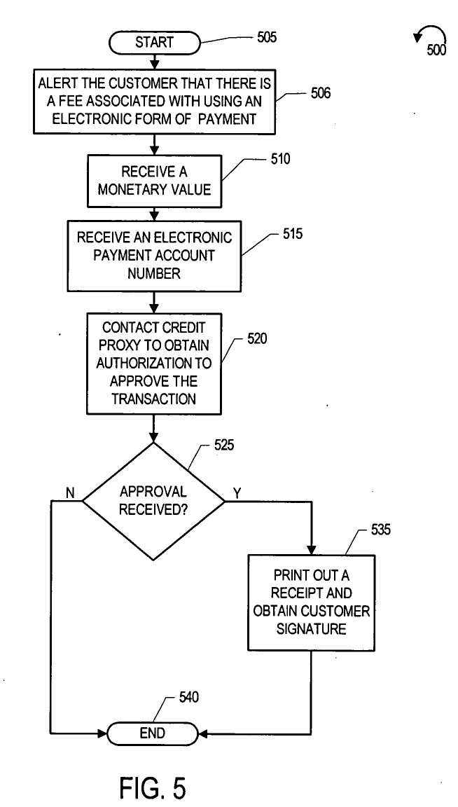

FIG. 5 illustrates an terminal side credit proxy method 500, implemented in accordance with one embodiment of the invention. In one embodiment, method 500 may be executed by the terminal 351 of FIG. 3. In one embodiment, method 500 begins at step 505, with a customer wanting to make a payment using an electronic payment method, such as a credit card, at a participating retailer.

A retailer may receive a terminal 351 from the operator of the credit proxy 326 service after becoming a client of the service. In one embodiment, the retailer's existing equipment can be used to work with the credit proxy 326 service. In one embodiment, to become a client, retailers can review and sign a credit proxy agreement, which can be, for example, similar to a retailer agreement provided by a credit card processor and/or an acquiring bank. The credit proxy agreement can provide for the placement of a terminal at the retailer's point of sale (POS), and give the credit proxy 326 service provider the right to debit and credit the a Demand Deposit Account (DDA) designated by the retailer. The agreement may also detail the terms and conditions of the relationship including chargeback procedures, deposit schedules, installation fees, network connectivity fees, training, the cost/lease of the terminal, etc.

In step 506, the customer is alerted to the fact that there is a fee associated with using an electronic form of payment for goods and services at the retailer. The fee may be a fixed fee, a fixed fee plus a percentage of the sale, or just based upon a percentage. In one embodiment, the terminal 351 has signage, such as, for example, an electronic display, stickers, decals, signs or the like indicating that there is a fee associated with using an electronic form of payment. In addition, a retailer may inform the customer that using an electronic form of payment will result in an additional fee. In one embodiment, step 506 is omitted.

If the customer wants to proceed with payment, processing of method 500 proceeds from step 506 to step 510, where the terminal 351, is provided a monetary value. The monetary value represents the base value of the transaction. The base value of the transaction can comprise the cost of goods and/or services, inclusive of, for example, taxes and tip. In one embodiment of the invention, the terminal 351 can receive this monetary value from a keypad, in one embodiment, the terminal can be provided this value by a POS terminal coupled to the terminal 351. In one embodiment a POS terminal can directly receive the monetary value and execute any of the steps of the invention.

Processing then proceeds from step 510 to step 515, where the terminal 351 receives an electronic payment account identifier, for example, a credit or debit card number. The terminal can obtain the identifier using a swipe reader, a camera, a barcode reader, an RFID reader, or any other module that can be used to input information into the terminal 351. In the case of a debit card, an additional personal identification number (PIN), may also be required by the terminal 351, as is known in the art.

The order of steps 510 and 515 are not particularly significant to the invention, and thus, in one embodiment, their order is reversed.

In one embodiment, the terminal 351 presents to the customer a calculated total for the transaction charge on its displays in advance of attempting to request authorization for the transaction. In this embodiment (not shown), step 510 and 515 precede step 506, and additional steps (not shown) (i) display the total transaction value before step 506, and (ii) require that the customer authorize the total amount also before step 506.

Processing proceeds to step 520, where the terminal 351 contacts the credit proxy 326 service provider to obtain authorization to approve the transaction. This authorization request can comprise a base transaction value, an account identifier and a retailer reference. As will be discussed below, the credit proxy 326 service provider processes the request and returns an approval or denial.

In step 525, if the terminal receives a denial for the transaction, processing proceeds from step 525 to step 540 where the method ends. The customer can try another credit card, pay in cash, or cancel the sale.

Returning to step 525, if an approval is received by the terminal, processing proceeds from step 525 to step 535, where a receipt may be printed and the customer's signature may be acquired. Step 535 is optional, and may or may not be required in some jurisdictions and under some circumstances. In one embodiment of the invention, the terminal 351 has a built in printer; in one embodiment, the terminal 351 can cause an attached POS terminal, printer, or other device to provide a receipt. In one embodiment, the terminal 351 may comprise a signature capture pad, and acquire a digital signature from a customer. The method 500 ends in step 540. The retailer may keep a copy of the receipt and provide one for the customer.

In one embodiment of the invention (not shown), the customer's signature is obtained in advance of contacting the credit proxy 326, and may be transmitted to the credit proxy 326 with the request to obtain authorization. In such an event, the credit proxy 326 may retain the signature in connection with the record of the transaction. In one embodiment, the signature could also be provided to the credit processor 336 by the credit proxy 326. The credit processor 336 could authenticate the signature as part of its charge to approve or deny the transaction.

In the event a signed receipt is obtained, the retailer may retain a copy of the signed receipt for a predetermined length of time, for example, 90 days, as evidence of the transaction. In one embodiment, the terminal can send a digital copy of the receipt, including the customer's signature, to the credit proxy 326 service provider, who can digitally store the receipt for the retailer. In one embodiment of the invention, the digital signature can be used to verify the identify of the card holder, by comparing the received signature to a verified signature and/or signatures received in the past.

The customer may receive a statement from the bank issuing the card account at the end of the issuing bank's monthly billing cycle. In one embodiment, on that statement the credit proxy 326 service transaction can show the base transaction value and the added fee or fees. The description of the transaction may also include a toll free number for the cardholder to call with questions and/or an informational URL. For example, in one embodiment of the invention, the credit proxy 326 service provider can allow a customer to view their transactions through a secure website over the Internet, or any other data network. In addition or alternatively, retailers can have their own websites that can have links to a customer's transactions.

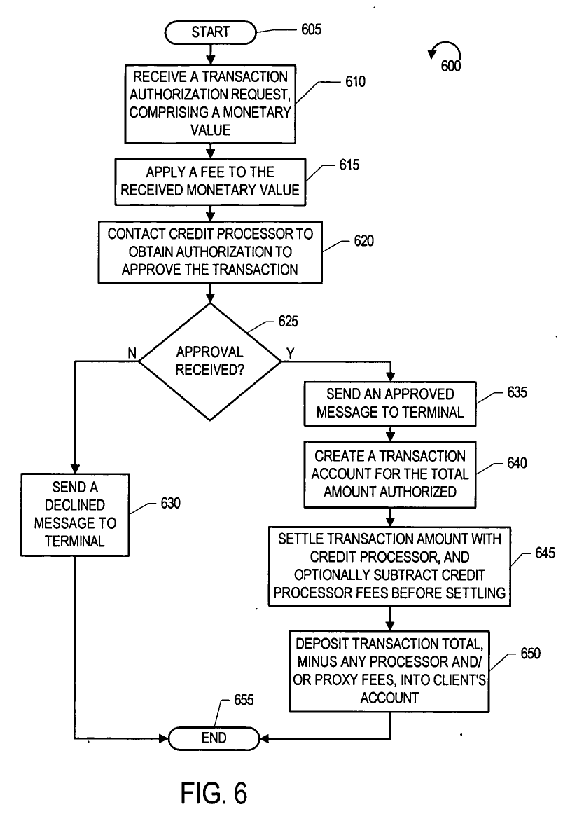

FIG. 6 illustrates a credit proxy 326 service provider side method 600 of a credit proxy 326 service, implemented in accordance with one embodiment of the invention. In one embodiment, the credit proxy service module 340 of FIG. 1 executes method 600. Method 600 starts at step 605.

At step 610, a credit proxy computer 326, receives a transaction authorization request from a terminal. As mentioned above, the request comprises at least a monetary value and an account identifier. Following step 615, processing proceeds to step 620, where an appropriate fee is applied to the received monetary value. This fee covers the cost of the credit card transaction and can also includes an additional fee for the credit proxy 326 service. In one embodiment of the invention, the fee is added to the monetary value by the terminal 351 before it transmits the transaction to the credit proxy service computer 326. Thus, the monetary value included in the request accounts for the credit proxy service fee, and credit proxy service computer 326 does not have to perform step 615.

Following step 615, processing proceeds to step 620, where the credit proxy service computer 326, contacts a credit processor 336 to obtain approval for the transaction. In one embodiment, the credit processor 336 establishes a retailer relationship with a credit proxy 326-service provider, in advance of step 620. The credit proxy 326 service may sign a retailer agreement with the credit proxy 326 service provider, and the credit proxy 326 service provider may maintain a DDA for the credit processor 336 to make debits and credits based on credit card sales, returns and associated fees. The credit processor 336 can issue the credit proxy 326 service provider Retailer Identification Numbers (RIDs) that correlate with the credit proxy 326 service's clients. For example, ABC taxi, a hypothetical credit proxy 326 service client, is assigned a unique RID.

In step 625, in one embodiment, if a transaction is declined, processing proceeds to step 630, where the credit proxy computer 326 send a declined message to the terminal 351. Then the method ends in step 655.

Returning to step 625, if a transaction is approved by a credit processor 336, processing proceeds from step 625 to step 635, where the credit proxy computer 326 sends an approved message to the terminal 351. Following step 635, processing proceeds to step 640, where the credit proxy computer 326 creates a transaction account for the total amount authorized by the credit processor 336. Then, in step 645, the transaction value minus the credit processor's fees is settled by the credit processor 336 and deposited into the credit proxy 326 service provider's DDA. In one embodiment, the transaction is settled within 48 hours.

In one embodiment, (not shown) the credit processor does not immediately take out their fee, in step 645, and instead credits the credit proxy 326 the transaction value. At a later time (e.g., at the end of the month), the credit processor 336 makes a batch debit and collects all their fees at once.

Once the credit processor 336 has settled the transaction, processing proceeds to step 650, where the credit proxy 326 service provider deposits an appropriate amount into its client DDA. This amount is the transaction value minus any credit processor 336 and/or credit proxy 326 service fees. In one embodiment of the invention, as the credit proxy 326 service provider settles its client DDA, the credit proxy 326 service provider also transfers a credit proxy fee from its DDA to a Holding Account DDA, thereby leaving a correct amount for a credit processor 336 to debit for its fees. Method 600 ends in step 655.

In one embodiment (not shown), instead of executing steps 645 and 650, the credit processor 336 settles the transaction value with the client DDA and separately settles the surcharge with the credit proxy 326. The credit processor 336 can take its fee before settling the surcharge with the credit proxy 326, or the credit processor 336 can take a batch fee at the end of a time period.

In one embodiment (not shown), in step 645, the credit processor 336 can credit the transaction value to a client DDA, instead of a credit proxy 326 DDA. In step 650, the credit proxy 326 can debit the client DDA for their fees. The credit processor 336 can take their fees before crediting the client DDA or in a batch from the credit proxy 326 DDA at the end of a pay period.

In embodiments of the invention, transaction data can be provided to the retailer at a secure URL provided by the credit proxy 326 service provider.

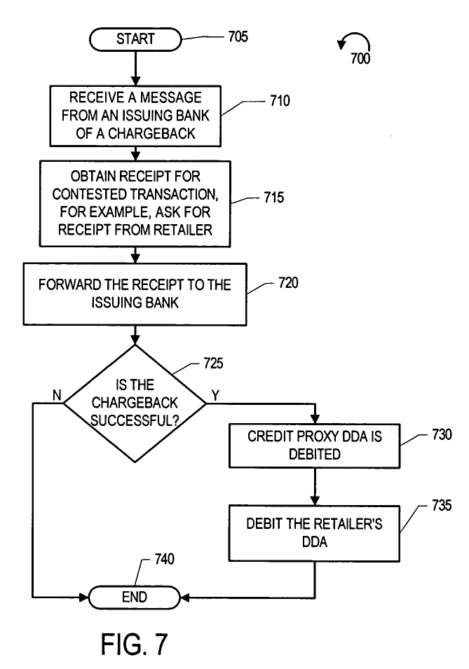

As known in the art, a chargeback occurs when a cardholder contacts the issuing bank, i.e., the bank that issued their card, and contests a charge. In the event that a cardholder chargebacks a transaction to their issuing bank, the credit proxy 326 service provider can be contacted by the credit processor 336 and may follow a normal chargeback procedure. FIG. 7 illustrates a chargeback method 700 implemented in accordance with one embodiment of the invention. Method 700 starts at step 705, and proceeds to step 710, where the credit proxy 326 service provider receives a message from an issuing bank informing the service provider of a chargeback.

Then, method 700 proceeds from step 710 to step 715, where the credit proxy 326 service provider obtains the receipt for the contested transaction. In one embodiment, the credit proxy 326 service provider can contact an affected retailer asked them to retrieve and forward the receipt associated with the contested transaction. In one embodiment, the credit proxy 326 service provider may already have a copy of the receipt. Then, in step 720, the credit proxy 326 service provider forwards the receipt to the issuing bank.

In step 725, the issuing bank determines whether the chargeback is successful. If the chargeback is successful, method 700 proceeds from step 725 to step 730, where the credit proxy 326 service provider's DDA is debited by the issuing bank for the contested amount; and in step 735, the retailer's DDA is debited an equal amount and a fee. Then, method 700 ends in step 740. Returning to step 725, if the chargeback is not successful, method 700 ends in step 740.

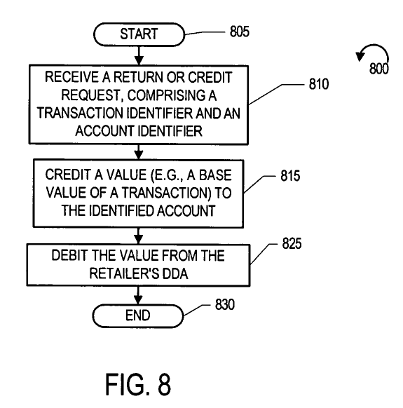

FIG. 8 illustrates an exemplary return/credit method 800 implemented in accordance with one embodiment of the invention. Method 800 starts in step 805. Then, in step 810 the credit proxy 326 service provider receives a request to return an item or to credit a customer's account. In an embodiment, the request comprises a transaction identifier and an account identifier. In step 815, the credit proxy 326 service provider credits the identified account, and in step 825, the credit proxy 326 service provider initiates a debit to the retailer's DDA for the amount of the return/credit. Then, method 800 ends in step 830. Credit proxy service fees may or may not be returned and any new fees can be passed on to the retailer. For example, in one embodiment, in step 815, the credit proxy 326 credits only the base value of the transaction, and not the surcharge, to the identified account. Then, in step 825, only the base value of the transaction is debited from the retailer's DDA.

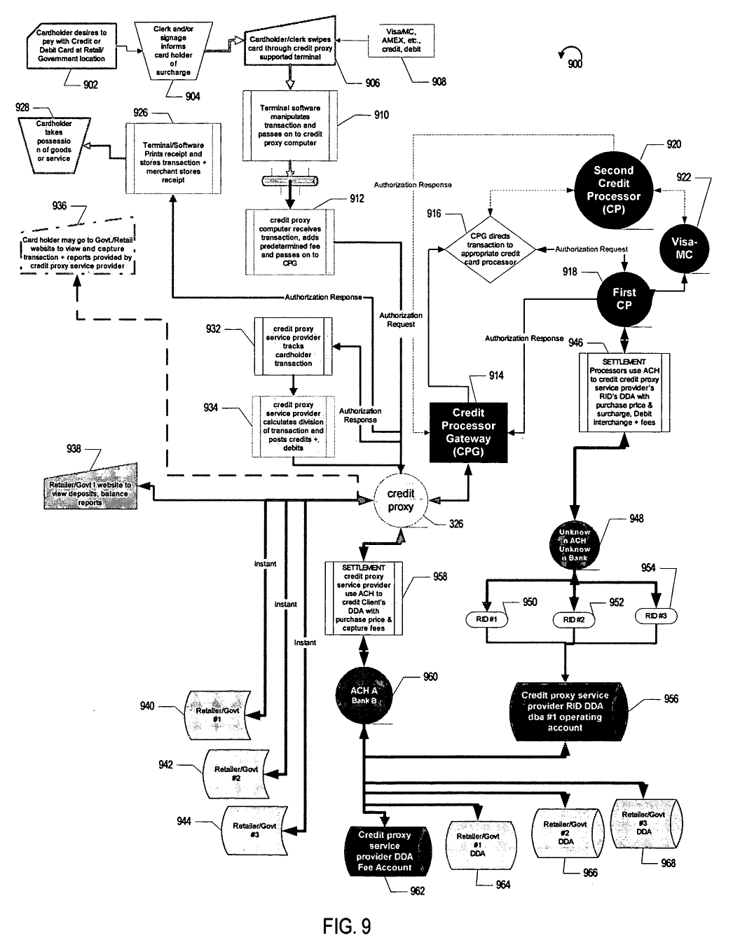

FIG. 9 illustrates a schematic drawing of a transaction 900, implemented in accordance with one embodiment of the invention. The transaction 900 begins in step 902, where a cardholder desires to pay for a debt owed with a credit card. Then, in step 904, a clerk at the store and/or a display on a payment terminal inform the cardholder that there is surcharge for paying with a card. If the cardholder agrees, in step 906, the clerk or the cardholder swipes their card 908 at the terminal. The terminal may also be provided with a monetary value for the transaction. In one embodiment, the monetary value is input through a keypad on the terminal.

Following step 906, processing proceeds to step 910, where the terminal 351 manipulates the transaction and passes it to a credit proxy computer 326. In step 912, the credit proxy computer 326 receives the transaction, adds a predetermined fee and passes it onto a credit processing gateway, such as, for example, a RITA server 914, via a credit proxy 326 network connection, for authorization. In one embodiment, instead of a RITA server 914 another computer with similar software or service capabilities can be used. From step 912, processing proceeds to step 916, where the RITA server 914 directs the transaction to an appropriate credit processor. For example, the authorization request can go to a first credit processor 918, or a second credit processor 920. The credit processor can also communicate with a credit card company 922 to determine whether to authorize a transaction. In one embodiment, the credit proxy computer 326 is directly coupled to the credit processors 918/920.

If a transaction is authorized, the credit processor 918/920 sends an authorization response to the credit proxy computer 326, and processing proceeds to both steps 926 and step 932. In addition, the credit processor 918/920 also settles the transaction in step 946. In step 926, an authorization response is sent to the terminal, which then prints out a receipt and stores the transaction. The cardholder signs the receipt and may keep a copy. Another copy of the receipt may be retained by the retailer. Following step 926, in step 928, the cardholder takes possession of the goods and/or the retailer completes their services and the transaction for the cardholder is complete. In step 932, the credit proxy 326 service provider tracks the cardholder transaction, for example, by creating a transaction account, and in step 934, the credit proxy 326 service provider calculates the division of the transaction and posts debits and or credits.

In one embodiment, every transaction is saved by the credit proxy 326 service provider and can be organized by client as shown in data structures 940, 942 and 944. In step 938, the transaction information is posted to a website so that the retailer can view their transaction history. In addition, in step 936, the transaction history of a particular cardholder is also made available to the cardholder through the retailer and/or directly from the credit proxy 326 service provider.

In settlement step 946, the credit processor 918/920 uses an Automated Clearing House (ACH) 948 to credit the appropriate Retailer Identification numbers (RIDs) 950, 952, 954, in the credit proxy 326 service provider's DDA 956. Once a credit is received from a credit processor and posted in the credit proxy 326 service provider DDA 956, processing proceeds to step 958, where the credit proxy computer 326 uses an ACH 960 to credit the appropriate retailer's DDA 964, 966, 968. Any credit proxy fees are deducted from the credited value and placed in credit proxy 326 service provider DDA fee account 962, before a retailer's DDA is credited.

As described above, the fees associated with accepting various forms of electronic payment can be transferred from the retailer to the customer by using a credit proxy 326. When a customer wants to use a form of electronic payment, a retailer provides the credit proxy 326 with a monetary value of the transaction and an account identifier. The credit proxy 326 adds a fee to the monetary value, and obtains authorization to approve the transaction from the issuer of the customer's account or from an agent of the issuer. If the transaction is approved, the customer is charged for the monetary value plus the fee, and the retailer is credited with the monetary value. Thus, the retailer receives the full value of their goods and/or services, and the customer pays for the fees associated with electronic payments.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method of charging electronic payment fees to a customer comprising:
receiving a first transaction authorization request from a retailer, the first transaction authorization request comprising a customer account identifier and a monetary value for a transaction;
transmitting a second transaction authorization request to a credit processor, the second transaction authorization request comprising the customer account identifier and a total transaction cost, the total transaction cost comprising a surcharge added to the monetary value;
receiving an authorization for the second transaction request from the credit processor;
receiving a credit;
creating a credit in favor of the retailer; and
the credit processor creating a charge to the customer in the amount of the total transaction cost.

2. The method of claim 1, wherein the first transaction authorization request further comprises a retailer reference number.

3. The method of claim 1, wherein the credit received is from the credit processor and is in the amount of the total transaction.

4. The method of claim 1, wherein the credit processor debits a batch of fees at the end of a time period.

5. The method of claim 1, wherein the credit received is from the credit processor and is in the amount of a net value of the total transaction.

6. The method of claim 1, wherein the step of creating a credit in favor of the retailer is performed by the credit processor, and wherein the credit to the retailer is in the amount of the total transaction, and wherein the step of receiving a credit comprises receiving the surcharge from the retailer.

7. The method of claim 1, further comprising the step of transmitting an authorization for the first transaction request to the retailer.

8. The method of claim 7, further comprising the step of transmitting the total transaction cost to the retailer.

9. The method of claim 8, wherein the retail provides the customer a receipt indicating the total transaction cost.

10. The method of claim 1, wherein the first transaction authorization request additionally comprises a digital signature of the customer.

11. The method of claim 10, further comprising the step of retaining a record of the first transaction request for a predetermined period.

12. The method of claim 10, wherein the second transaction authorization request additionally comprises a digital signature of the customer.

13. The method of claim 1, further comprising the step of retaining a record of the first transaction request for a predetermined period.

14. The method of claim 5, wherein the net credit received from the credit processor is in an amount not less than the monetary value and not more than the total transaction cost.

15. The method of claim 14, wherein the net credit received from the credit processor comprises the amount of the total transaction cost less the processing and interchange fees of the credit processor.

16. The method of claim 15, wherein the surcharge includes a fixed per transaction fee plus a percentage of the total transaction cost.

17. The method of claim 15, wherein the surcharge includes a fixed per transaction fee plus a percentage of the monetary value.

18. The method of claim 14, wherein the credit in favor of the retailer in the amount of the monetary value.

19. The method of claim 1, wherein the credit in favor of the retailer is less than the monetary value.

20. The method of claim 14, wherein the credit in favor of the retailer is more than the monetary value.

21. A method of charging electronic payment fees to a customer comprising:
receiving a first transaction authorization request from a retailer, the first transaction authorization request comprising a customer account identifier and a monetary value for a transaction;
transmitting a second transaction authorization request to a credit processor, the second transaction authorization request comprising the customer account identifier and a total transaction cost, the total transaction cost comprising a surcharge added to the monetary value;
receiving an authorization for the second transaction request from the credit processor;
receiving a credit from the credit processor in the amount of the total transaction cost;
creating a credit in favor of the retailer in the amount of the total transaction value; and
the credit processor creating a charge to the customer in the amount of the total transaction cost and debiting a batch of fees at the end of a time period.

22. A credit proxy computer coupled to a communication network, the credit proxy computer comprising:
a processor;
a communication module; and
memory, having stored thereon at least one routine, said routine executing commands comprising:
receiving a request from a terminal to approve a transaction, the request including a first value;
calculating a second value by adding a surcharge to the first value;
contacting a credit processor to obtain authorization to approve the transaction, the request including the second value;
receiving a decision from the credit processor; and
providing an indication of the decision to the terminal.

23. The credit proxy computer of claim 22, wherein the decision authorizes the transaction, the at least one routine executing commands additionally comprising:
processing a credit from the credit processor; and
providing a credit to an account associated with the terminal.

24. The credit proxy computer of claim 23, wherein the credit from the credit processor is in the amount of the surcharge.

25. The credit proxy computer of claim 23, wherein the credit from the credit processor is in the amount of the second value.

26. The credit proxy computer of claim 24, the at least one routine executing commands additionally comprising processing a debit from the credit processor for processing and interchange fees associated with the transaction.

27. The credit proxy computer of claim 26, wherein the debit is a batch debit comprising the fees for a plurality of transaction.

28. The credit proxy computer of claim 22, wherein the decision authorizes the transaction, the at least one routine executing commands additionally comprising:
debiting the surcharge from an account associated with the terminal; and
processing a debit from the credit processor.

29. A charge system for permitting a customer to tender payment to a retailer in the form of a credit card, the charge system comprising:
a terminal for receiving transaction information comprising a customer account identifier and a transaction value;
the terminal being adapted to transmit a request for authorization to a merchant system and to receive an indication of the result of such authorization request from the merchant system;
the merchant system being adapted: to compute a surcharge to the transaction value, to transmit a request for authorization to a credit processing system, the request including the surcharge, to receive an indication of the result of such authorization request from the credit processing system, to receive a credit from the credit processing system, and to provide a credit to an account associated with the terminal; and
the credit processing system being adapted to receive requests for authorization, to make credits for approved requests, and to charge an account associated with the customer account identifier in the amount of any approved request.

30. The system of claim 29, wherein the transaction information further comprises a retailer reference number.

31. A terminal comprising:
an account identifier capture module;
a monetary value receiver; and
a communication module, wherein said terminal uses the communication module in at least one routine comprising,
requesting an authorization from a credit proxy system to approve a transaction for a first amount, the credit proxy system obtaining authorization for a transaction from a credit processor for a second amount; and
receiving an indication of the decision for said authorization request of the transaction for the second amount, and if the indication is positive, receiving an indication of the second amount.

32. The terminal of claim 31, wherein the terminal is a mobile terminal, and wherein the mobile terminal can communicate wirelessly with a credit proxy system.

33. The terminal of claim 31, further comprising a signature capture pad.

34. The terminal of claim 31, further comprising a printer.

35. The terminal of claim 31, wherein the account identifier capture module can be implemented as at least one selected from the group comprising: a keypad, a magnetic strip reader, a data form scanner, a radio frequency identification reader, a camera, a computer or a point of sale terminal.

36. The terminal of claim 31, wherein the monetary value is received from at least one selected from the group comprising: a keypad, a magnetic strip reader, a data form scanner, a radio frequency identification reader, a camera, a computer or a point of sale terminal.

37. A terminal comprising:
an account identifier capture module;
a monetary value receiver; and
a communication module, wherein said terminal uses the communication module in at least one routine comprising,
receiving a value for a transaction for a first amount;
requesting an authorization from a customer to approve a transaction for a second amount;
requesting an authorization from a credit proxy system to approve the transaction for the second amount, the credit proxy system obtaining authorization for a transaction from a credit processor for a second amount; and
receiving an indication of the decision for said authorization request of the transaction for the second amount, and if the indication is positive, receiving an indication of the second amount.

38. The terminal of claim 37, wherein the at least one routine executes commands additionally comprising requesting a second amount from the credit proxy system.

39. The terminal of claim 37, wherein the at least one routine executes commands additionally comprising calculating the second amount at the terminal.

40. The terminal of claim 39, wherein the at least one routine executes commands additionally comprising receiving an algorithm to calculate the second amount from the credit proxy system.
